(19) United States
(12) Patent Application Publication
(10) Pub. No.: US 2017/0073049 A1
(43) Pub. Date: Mar. 16, 2017

(54) Digital Dashboard Control System for Motorized Vehicle

(71) Applicant: Vern Schoore, Angola, IN (US)

(72) Inventor: Vern Schoore, Angola, IN (US)

(21) Appl. No.: 14/854,960

(22) Filed: Sep. 15, 2015

(51) Int. Cl. B63B 49/00; G06F 3/0482; G06F 3/0488; G06F 3/044

(52) U.S. Cl. CPC B63B 49/00; G06F 3/044; G06F 3/0482; G06F 3/0488

(57) ABSTRACT

A control system for the operation of a boat, said control system comprising: a power source, said power source operably attached to a boat function selected from the group consisting of the bilge motor, dashboard lights, horn, dock lights, and tilt motor; a dashboard comprising a plurality of capacitive touch digital switches, wherein at least one of said switches comprises a trinary functionality and each switch of said plurality of switches is disposed in electronic communication with at least one of said boat functions through a control board such that each switch of said plurality of switches can activate and deactivate at least one boat function; a means for visually displaying the operational state of each of each of said boat function, said visual display means operationally connected to said power source, to at least one switch of said plurality of switches, and to said control board such that said system is in bidirectional communication with said display means and said boat functions.

### CROSS REFERENCE To RELATED APPLICATIONS

This is a non-provisional application based upon U.S. provisional patent application Ser. No. 14/486,592, entitled “Digital Dashboard Control System for Motorized Vehicle”, filed Sep. 15, 2014, and incorporates the disclosure therein.

Page 3 of 18

### BACKGROUND

1. Field of the Art

The present invention relates generally to touch screen control systems, especially those used for motorized vehicles. More specifically, the present invention relates to a touch screen control system integrated into the dashboard of a motorized vehicle such as a boat or other watercraft.

2. Description of the Prior Art

In electrical engineering, capacitive sensing is a technology that incorporates human body capacitance as an input. Capacitive sensors detect anything that is conductive or has a dielectric different from that of air. Many types of sensors use capacitive sensing, including sensors to detect and measure proximity, position or displacement, humidity, fluid level, and acceleration. Human interface devices based on capacitive sensing, such as trackpads, can replace the computer mouse. Digital audio players, mobile phones, and tablet computers use capacitive sensing touchscreens as input devices. Capacitive sensors can also replace mechanical buttons.

Capacitive sensors are constructed from many different media, such as copper, Indium tin oxide (“ITO”) and printed ink. Copper capacitive sensors can be implemented on standard FR4 printed circuit boards (“PCBs”) as well as on flexible material. ITO allows the capacitive sensor to be up to 90% transparent (for one layer solutions, such as touch phone screens). Size and spacing of the capacitive sensor are both very important to the sensor's performance. In addition to the size of the sensor, and its spacing relative to the ground plane, the type of ground plane used is very important. Since the parasitic capacitance of the sensor is related to the electric field's path to ground, it is important to choose a ground plane that limits the concentration of e-field lines with no conductive object present.

Designing a capacitance sensing system requires first picking the type of sensing material (FR4, Flex, ITO, etc.). One also needs to understand the environment the device will operate in, such as the full operating temperature range, what radio frequencies are present and how the user will interact with the interface.

In surface capacitive technology, only one side of the insulator is coated with conductive material. A small voltage is applied to this layer, resulting in a uniform electrostatic field. When a conductor, such as a human finger, touches the uncoated surface, a capacitor is dynamically formed. Because of the sheet resistance of the surface, each corner is measured to have a different effective capacitance. The sensor's controller can determine the location of the touch indirectly from the change in the capacitance as measured from the four corners of the panel: the larger the change in capacitance, the closer the touch is to that corner. With no moving parts, it is moderately durable, but has low resolution, is prone to false signals from parasitic capacitive coupling, and needs calibration during manufacture. Therefore, it is most often used in simple applications such as industrial controls and interactive kiosks.

Projected capacitive touch (“PCT”) technology is a capacitive technology which allows more accurate and flexible operation, by etching the conductive layer. An X-Y grid is formed either by etching one layer to form a grid pattern of electrodes, or by etching two separate, perpendicular layers of conductive material with parallel lines or tracks to form the grid; comparable to the pixel grid found in many liquid crystal displays (LCD).

The greater resolution of PCT allows operation with no direct contact. The conducting layers can be coated with further protective insulating layers and operate even under screen protectors, or behind weather and vandal-proof glass. Because the top layer of a PCT is glass, PCT is a more robust solution versus resistive touch technology. Depending on the implementation, an active or passive stylus can be used instead of or in addition to a finger. This is common with point of sale devices that require signature capture. Gloved fingers may or may not be sensed, depending on the implementation and gain settings. Conductive smudges and similar interference on the panel surface can interfere with the performance. Such conductive smudges come mostly from sticky or sweaty finger tips, especially in high humidity environments. Collected dust, which adheres to the screen because of moisture from fingertips, can also be a problem.

There are two types of PCT: self capacitance, and mutual capacitance. Mutual capacitive sensors have a capacitor at each intersection of each row and each column. A 12-by-16 array, for example, would have 192 independent capacitors. A voltage is applied to the rows or columns. Bringing a finger or conductive stylus near the surface of the sensor changes the local electric field which reduces the mutual capacitance. The capacitance change at every individual point on the grid can be measured to accurately determine the touch location by measuring the voltage in the other axis. Mutual capacitance allows multi-touch operation where multiple fingers, palms or styli can be accurately tracked at the same time.

Self-capacitance sensors can have the same X-Y grid as mutual capacitance sensors, but the columns and rows operate independently. With self-capacitance, current senses the capacitive load of a finger on each column or row. This produces a stronger signal than mutual capacitance sensing, but it is unable to resolve accurately more than one finger, which results in “ghosting”, or misplaced location sensing.

Capacitive touch sensors often utilize transistor-transistor logic (TTL). TTL is a class of digital circuits built from bipolar junction transistors (BJT) and resistors. It is called transistor-transistor logic because both the logic gating function (e.g., AND) and the amplifying function are performed by transistors (contrast with RTL and DTL).

TTL is notable for being a widespread integrated circuit (IC) family used in many applications such as computers, industrial controls, test equipment and instrumentation, consumer electronics, synthesizers, etc. The designation TTL is, sometimes used to mean TTL-compatible logic levels, even when not associated directly with TTL integrated circuits, for example as a label on the inputs and outputs of electronic instruments.

After their introduction in integrated circuit form in 1963 by Sylvania, TTL integrated circuits were manufactured by several semiconductor companies, with the 7400 series by Texas Instruments becoming particularly popular. TTL manufacturers offered a wide range of logic gate, flip-flops, counters, and other circuits. Several variations from the original bipolar TTL concept were developed, giving circuits with higher speed or lower power dissipation to allow optimization of a design. TTL circuits simplified design of systems compared to earlier logic families, offering superior speed to resistor-transistor logic (RTL) and easier design layout than emitter-coupled logic (ECL). The design of the input and outputs of TTL gates allowed many elements to be interconnected.

TTL became the foundation of computers and other digital electronics. Even after much larger scale integrated circuits made multiple-circuit-board processors obsolete, TTL devices still found extensive use as the “glue” logic interfacing more densely integrated components. TTL devices were originally made in ceramic and plastic dual-in-line (DIP) packages, and flat-pack form. TTL chips arc now also made in surface-mount packages. Successors to the original bipolar TTL logic often are interchangeable in function with the original circuits, but with improved speed or lower power dissipation.

Touchpad user interfaces can be built on PCBs with substrate options such as rigid FR4, flexible polyimide, and flexible polyester for multidimensional designs. Sealed capacitive switches are highly resistant to moisture, dust, harsh chemical exposure, contaminants and EMI, making them exceptionally durable in demanding medical equipment applications. Touch screens feature an easy-to-read, light-enabled surface that's easy to clean. Available in virtually any non-conductive material, overlays offer a variety of cosmetic surfaces, such as glass, polycarbonate, polyester, leather, wood, or acrylic.

Capacitive touchpads allow more creative and functional use of light than membrane switches. The capacitive field senses at a distance great enough to accommodate the insertion of lighting elements and a light guide, which allows optimal design flexibility. There are virtually unlimited cosmetic and LED backlighting options for any icon or display shape, size and color. Active option keys may remain lit constantly. Keys can light on depression. Accidental activation of capacitive switches can be addressed by changing key sensitivity or time required to depress a key before actuation occurs.

In designs that don't require lighting elements, solid state capacitive panels can be constructed with an overlay of continuous sheet metal. Sheet metal requires more pressure to activate keys but affords greater protection against accidental activation and water spills or other unintentional contact. The technology can incorporate Braille or number keypad locators, and allows use with any type of glove.

Motorized vehicles such as watercraft typically include features such as instrument panels, audio systems, climate control systems, navigation systems, and other vehicle features all controlled by various switches and knobs often on the vehicle dashboard. A dashboard (also referred to as a dash or “dial and switch housing”) is generally a control panel typically positioned, by way of example, below the windshield of a vehicle, and typically includes or contains the instrumentation and controls pertaining to the operation of the vehicle. By way of example, such instruments or controls may include a speedometer, a tachometer, an odometer, a fuel gauge, an engine temperature gauge, an oil pressure gauge, an indicator for gear-shift position, a seat-belt warning indicator, an engine malfunction indicator, inside and outside lighting controls, heating and ventilation controls including inside and outside temperature gauges, a clock, audio system controls, a navigation system, among others. Many vehicle features are independent of each other. For example, vehicles typically have one set of controls for the climate control system and a separate set of controls for the audio system.

Prior art, mechanisms for controlling boat functions have several disadvantages which in most cases are related to the fact that previous forms of trim control systems require wiring or sliding metal contacts to connect the switches that one would actuate to control the relays that drive the trim mechanisms. Even retrofit kits have the disadvantage in that the cable leading from the switches to the power trim wiring harness often coils or wraps around the steering column or shaft when the steering wheel is rotated. This provides a very cumbersome system which is difficult to install, is susceptible to frequent failure from chaffing and tangling of the wires and is quite difficult and expensive to repair. Thus, there is a need to provide a control system for the powered mechanisms of a boat which system eliminates these disadvantages.

### SUMMARY

The present invention provides a “digital dashboard” that uses capacitive touch switches thereby replacing current mechanical switches being used in motorized vehicles, especially water craft, dashboard design and construction by vehicle manufacturers. A single capacitive assembly can replace dozens of mechanical switches and controls. Touch screen controllers reduce power consumption, improve accuracy, and require less frequent recalibration.

In one embodiment of the present invention, a vehicle includes a dashboard including one or more touchscreen displays; a wireless network interface; and multiple icons for presentation by one or more of the touchscreen displays to a user in the vehicle. Each of one or more of the icons is configurable by the user through tactile interaction with the icon via one or more of the touchscreen displays. Each of the icons when presented to the user makes accessible to the user through one or more of the touchscreen displays particular functionality.

Accordingly, the present invention comprises, in one exemplary embodiment, A control system for the operation of a boat, said control system comprising: a power source, said power source operably attached to a boat function selected from the group consisting of the bilge motor, dashboard lights, horn, dock lights, and other accessory functions; a dashboard comprising a plurality of capacitive touch digital switches, wherein at least one of said switches can comprises (configurable by rotary or dip switch) a trinary functionality and each switch of said plurality of switches is disposed in electronic communication with at least one of said boat functions through a control board such that each switch of said plurality of switches can activate and deactivate at least one boat function; a means for visually displaying the operational state of each of each of said boat function, said visual display means operationally connected to said power source, to at least one switch of said plurality of switches, and to said control board such that said system is in bidirectional communication with said display means and said boat functions.

In another exemplary embodiment, the present invention comprises a vehicle; a control system for the operation of a vehicle, said control system comprising: a power source, said power source operably attached to a vehicle function selected from the group consisting of the bilge motor, dashboard lights, horn, dock lights, and other accessory functions; a dashboard comprising a plurality of capacitive touch digital switches, wherein at least one of said switches comprises a trinary functionality and each switch of said plurality of switches is disposed in electronic communication with at least one of said vehicle functions through a control board such that each switch of said plurality of switches can activate and deactivate at least one vehicle function; a means for visually displaying the operational state of each of each of said vehicle function, said visual display means operationally connected to said power source, to at least one switch of said plurality of switches, and to said control board such that said system is in bidirectional communication with said display means and said vehicle functions.

In yet another exemplary embodiment, the present invention comprises a method of making a control system for a vehicle, said method comprising the steps of: providing a power source, said power source operably attached to a vehicle function selected from the group consisting of the bilge motor, dashboard lights, horn, dock lights, and other accessory functions; providing a dashboard comprising a plurality of capacitive touch digital switches, wherein at least one of said switches comprises a trinary functionality and each switch of said plurality of switches is disposed in electronic communication with at least one of said vehicle functions through a control board such that each switch of said plurality of switches can activate and deactivate at least one vehicle function; and providing a means for visually displaying the operational state of each of each of said vehicle function, said visual display means operationally connected to said power source, to at least one switch of said plurality of switches, and to said control board such that said system is in bidirectional communication with said display means and said vehicle functions.

In these and other exemplary embodiments of the present invention, the dashboard of the represent invention may be particularly designed for an automobile, such as a car, van, or truck; however, in alternate embodiments, the virtual dashboard may be particularly suited for a motorcycle, train, or various watercraft (e.g., boat, ship, etc.) or aircraft (e.g., airplane, jet plane, helicopter, etc.) as well as spacecraft or hovercraft. In particular embodiments, a virtual dashboard includes an interactive display implemented via one or more touchscreen displays in which one or more of the instruments and controls, such as those described above, may be implemented via interactive icons.

In still other exemplary embodiments, the virtual dashboard is customizable or configurable for specific vehicles. By way of example, a manufacturer may add, remove, rearrange, resize, reshape, or otherwise customize or reconfigure various icons including instruments and controls displayed by the dashboard. Benefits of the present invention include: fewer mechanical moving parts, reduced installation efforts, lowered system weight, reduced incidence of mechanical failure, reduced material expenses, reduced chances for loose wire connections and connection failures, and increased modularity.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

FIG. 1 shows an exemplary vehicle for use with the present invention.

FIG. 2 shows an exemplary dashboard in accordance with the present invention.

FIG. 3 shows an exemplary prior art wire harness for use with a boat.

FIG. 4 shows an exemplary functional schematic diagram of a control system in accordance with the present invention.

FIG. 5 shows an exemplary interactive panel in accordance with the present invention.

FIG. 6 shows a main PCB circuit diagram according to the present invention.

FIG. 7 shows a “daughter” PCB circuit diagram for the circuit of FIG. 6.

### DETAILED DESCRIPTION OF THE EMBODIMENTS

The present invention will be discussed hereinafter in detail in terms of the preferred embodiment according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscuring of the present invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations.

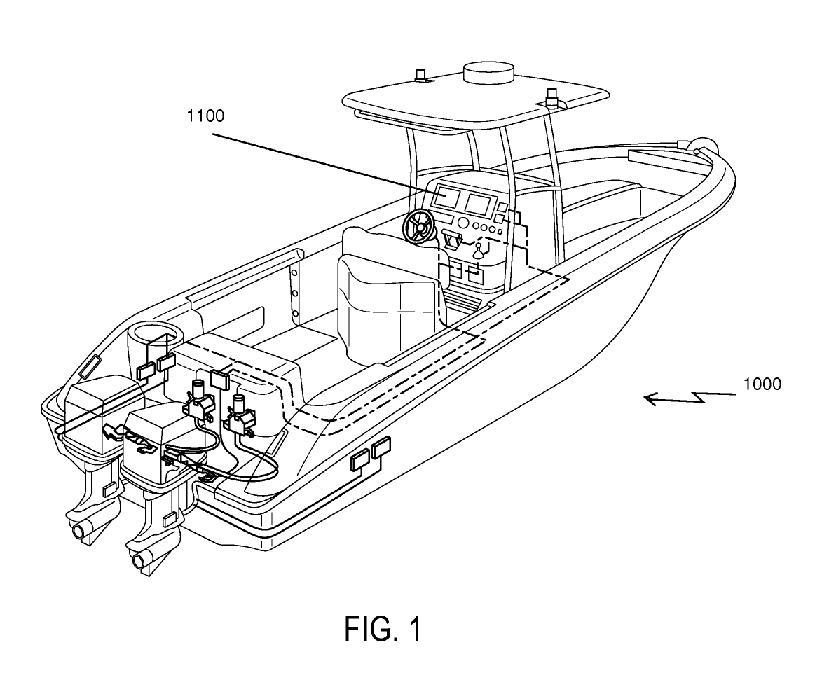

All of the implementations described below are exemplary implementations provided to enable persons skilled in the art to make or use the embodiments of the disclosure and are not intended to limit the scope of the disclosure, which is defined by the claims. In the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring first to FIG. 1, there is shown an exemplary vehicle 1000 for use with the present invention. A preferred use of the present invention is to incorporate the same into the dashboard of a boat or other watercraft. However, those of skill in the relevant art will appreciate that the present invention may be used for any vehicle, including automobiles, trucks, busses, boats, and electric vehicles. As illustrated in FIG. 1, the novel control device of the present invention is preferably housed within the dashboard of vehicle 1000 and operably connected to various boat functions as will be further described herein.

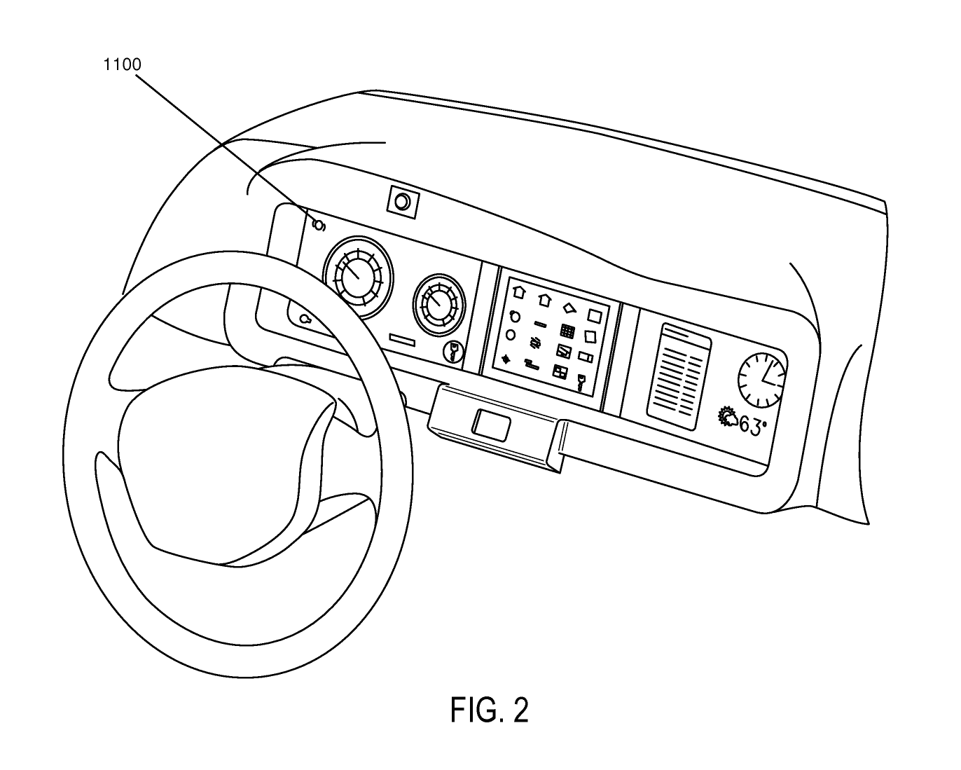

Referring next to FIG. 2, there is shown an exemplary dashboard 1100 in accordance with the present invention. Dashboard 1100 comprises a housing preferably constructed of a thermoset or thermoplastic polymer, composite, or other inexpensive, structurally sound, and water resistant material.

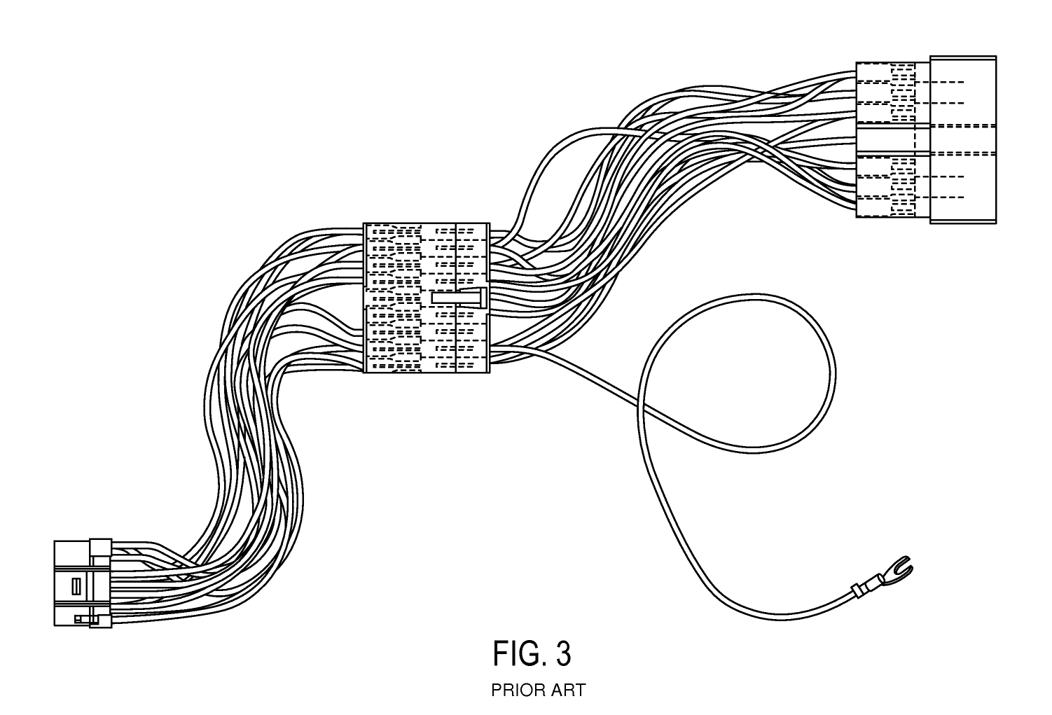

Referring next to FIG. 3, there is shown an exemplary prior art wire harness for use with a boat. In prior art vehicle dashboard designs, especially for watercraft, dashboards were attached to functional components of the vehicle via wire harnesses. Functional components of watercraft vehicles, for example, may include the bilge motor, dashboard lights, horn, dock lights, and other accessory functions.

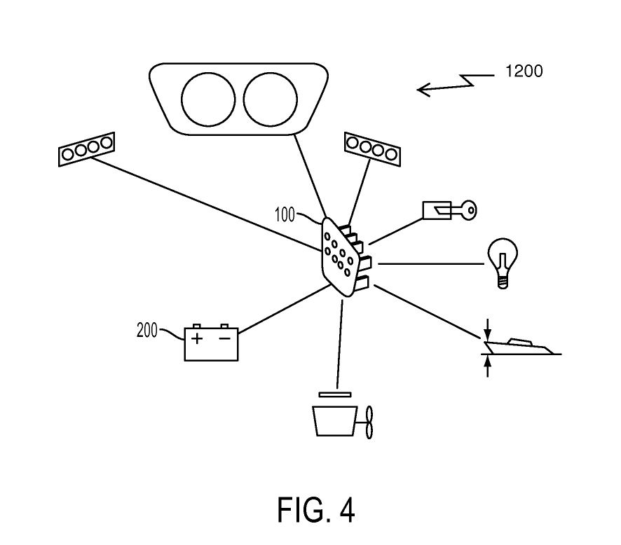

Referring now to FIG. 4, there is shown an exemplary functional schematic diagram of a control system in accordance with the present invention. As illustrated in FIG. 4, the control system 1200 of the present invention generally comprises a PCB & Microprocessor (ATMEL) operably connected to dashboard 1100 of the control system of the present invention. Additionally, the printed circuit board (PCB) 100 is further connected to power source 200 and various predetermined functional vehicle components.

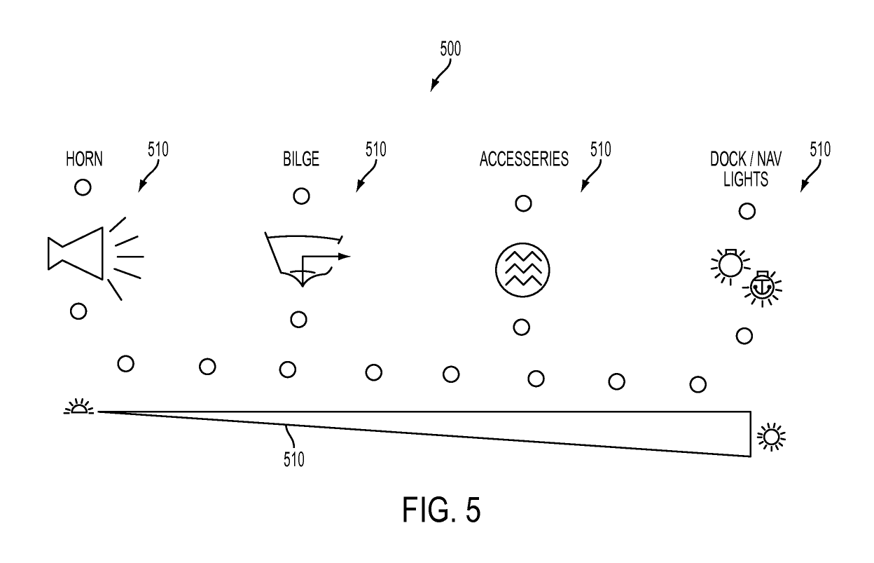

Referring now to FIG. 5, there is shown an exemplary interactive panel 500 in accordance with the present invention. As illustrated in FIG. 5, panel 500 includes a plurality of capacitive touch switches 510. There is no theoretical limit to the number of switches. However, the preferred embodiment includes at least four switches to operate the horn, bilge, lights, and “accessories,” of a common water vehicle. Additionally, a “variable” (stepped) capacitive switch is operable to control the level of illumination of control panel 500.

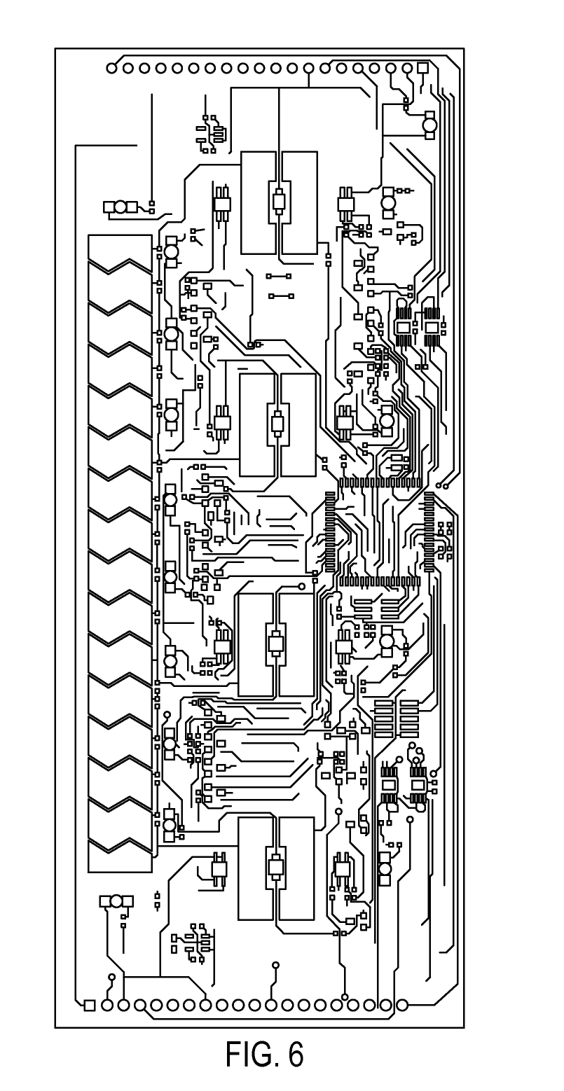

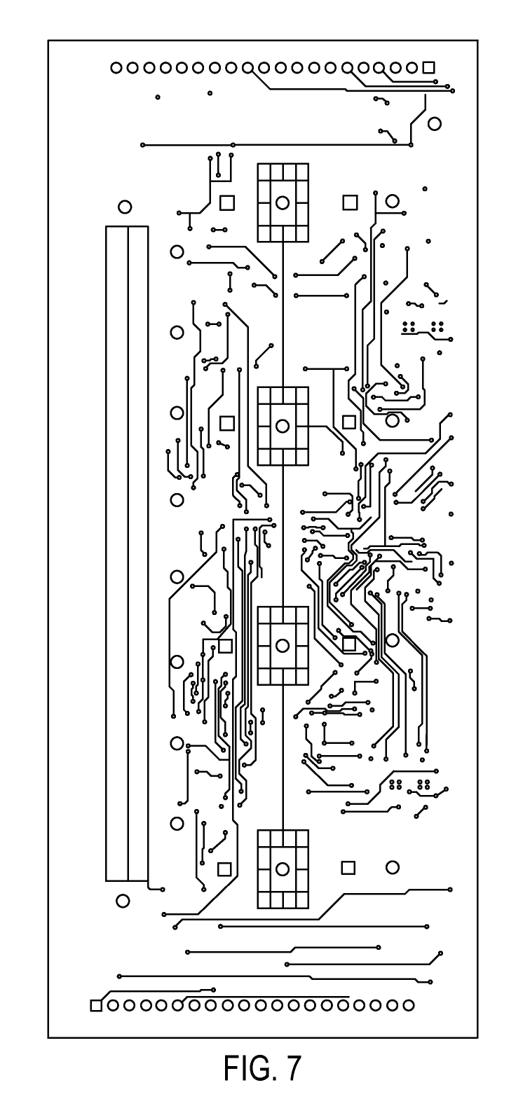

Referring next to FIG. 6, there is shown a main PCB circuit according to the present invention. Additionally, FIG. 7 shows a “daughterboard” circuit for the circuit of FIG. 6. The circuits shown in FIGS. 6 and 7 are electronically coupled to touch “surface” 500 illustrated in FIG. 5.

The above-described embodiments are merely exemplary illustrations set forth for a clear understanding of the principles of the invention. Many variations, combinations, modifications, or equivalents may be substituted for elements thereof without departing from the scope of the invention. It should be understood, therefore, that the above description is of an exemplary embodiment of the invention and included for illustrative purposes only. The description of the exemplary embodiment is not meant to be limiting of the invention. A person of ordinary skill in the field of the invention or the relevant technical art will understand that variations of the invention are included within the scope of the claims.

1. A control system for the operation of a vehicle, said control system comprising: a power source, said power source operably attached to a vehicle function selected from the group consisting of the bilge motor, dashboard lights, horn, dock lights, and other accessory functions; a dashboard comprising a plurality of capacitive touch digital switches, wherein at least one of said switches can comprises a trinary functionality and each switch of said plurality of switches is disposed in electronic communication with at least one of said vehicle functions through a control board such that each switch of said plurality of switches can activate and deactivate at least one vehicle function; a means for visually displaying the operational state of each of each of said vehicle function, said visual display means operationally connected to said power source, to at least one switch of said plurality of switches, and to said control board such that said system is in bidirectional communication with said display means and said vehicle functions.

2. A vehicle, said vehicle comprising: a control system for the operation of a vehicle, said control system comprising: a power source, said power source operably attached to a vehicle function selected from the group consisting of the bilge motor, dashboard lights, horn, dock lights, and tilt motor; a dashboard comprising a plurality of capacitive touch digital switches, wherein at least one of said switches comprises a trinary functionality and each switch of said plurality of switches is disposed in electronic communication with at least one of said vehicle functions through a control board such that each switch of said plurality of switches can activate and deactivate at least one vehicle function; a means for visually displaying the operational state of each of each of said vehicle function, said visual display means operationally connected to said power source, to at least one switch of said plurality of switches, and to said control board such that said system is in bidirectional communication with said display means and said vehicle functions.

3. A method of making a control system for a vehicle, said method comprising the steps of:
providing a power source, said power source operably attached to a vehicle function selected from the group consisting of the bilge motor, dashboard lights, horn, dock lights, and tilt motor; providing a dashboard comprising a plurality of capacitive touch digital switches, wherein at least one of said switches comprises a trinary functionality and each switch of said plurality of switches is disposed in electronic communication with at least one of said vehicle functions through a control board such that each switch of said plurality of switches can activate and deactivate at least one vehicle function; and providing a means for visually displaying the operational state of each of each of said vehicle function, said visual display means operationally connected to said power source, to at least one switch of said plurality of switches, and to said control board such that said system is in bidirectional communication with said display means and said vehicle functions.
